(19) United States
(12) Patent Application Publication
(10) Pub. No.: US 2023/0374676 A1
(43) Pub. Date: Nov. 23, 2023

(54) GAS DIFFUSION LAYER FOR ELECTROCHEMICALLY CONVERTING GAS

(71) Applicant: Nederlandse Organisatie voor toegepast-natuurwetenschappelijk onderzoek TNO, 's-Gravenhage (NL)

(72) Inventors: Earl Lawrence Vincent GOETHEER, Mol (BE); Carlos SÁNCHEZ MARTÍNEZ, Delft (NL); Elena PÉREZ GALLENT, Leiden (NL); Roman LATSUZBAIA, Delft (NL); Anca ANASTASOPOL, Pijnacker (NL)

(73) Assignee: Nederlandse Organisatie voor toegepast-natuurwetenschappelijk onderzoek TNO, 's-Gravenhage (NL)

(21) Appl. No.: 18/247,832

(22) PCT Filed: Oct. 8, 2021
(86) PCT No.: PCT/NL2021/050612

§ 371 Date: Apr. 4, 2023

(30) Foreign Application Priority Data
Oct. 9, 2020 (EP) 20201130.0

(51) Int. Cl. C25B 11/059; C25B 11/075; C25B 3/07; C25B 11/054; C25B 11/065

(52) U.S. Cl. CPC C25B 11/059; C25B 11/075; C25B 3/07; C25B 11/054; C25B 11/065

(57) ABSTRACT

The invention is directed to a process for electrochemically converting a reactant gas, to an electrolyser, to a gas diffusion electrode, to a method for producing a gas diffusion electrode, to a gas diffusion layer, and to the use of said gas diffusion layer and/or gas diffusion electrode.

The process comprises reacting a reactant gas at a gas diffusion electrode to form a product gas and/or a liquid product,

wherein the gas diffusion electrode comprises a gas diffusion layer comprising a non-porous layer that is permeable to carbon monoxide and/or carbon dioxide gas, and a porous layer, and
the reactant gas comprises carbon monoxide and/or carbon dioxide.

The invention is directed to a process for electrochemically converting a reactant gas, to an electrolyser, to a gas diffusion electrode, to a method for producing a gas diffusion electrode, to a gas diffusion layer, and to the use of said gas diffusion layer and/or gas diffusion electrode.

Gas diffusion electrodes are used for the electrochemical reaction between a gaseous phase (e.g., carbon dioxide) and a liquid phase (liquid electrolyte) in the presence of a solid catalyst. The electrochemical reaction takes place in an electrochemical cell with a gas diffusion electrode that comprises a catalyst layer (containing the catalyst) with the liquid electrolyte at one side and a gas diffusion layer through which the gas is diffused to supply the gaseous reactants to the catalyst layer on the other side.

Electrochemical conversion of gaseous reactants in a liquid phase have been studied in depth (e.g., carbon dioxide electroreduction to added value chemicals such as carbon monoxide, ethylene, formic acid, ethanol, etc.). It is considered that the electrochemical reaction occurs in the three-phase boundary layer where the catalyst (solid), the electrolyte (liquid) and the reactant (gas) coexist. One of the major drawbacks of the electrochemical conversion of gaseous reactants is the low solubility of those molecules in the liquid electrolyte. A low solubility leads to low reactant availability and thereby low conversion and production to added-value chemicals due to mass transfer limitations.

In order to increase the availability of gaseous reactants in the three-phase boundary layer where the reaction occurs, several researches have focused on the deconvolution of the gas supply (reactant) and the liquid supply (electrolyte) thereby avoiding the solubility issues of the gas reactant in the liquid phase. One commonly used strategy is the use of gas diffusion electrodes, where the catalyst layer is deposited on a porous conductive material with certain functionalities to supply the gas reactant from one side and the liquid electrolyte from the other side.

The porous material is known as gas diffusion layer since the gaseous reactants are able to diffuse through them in order to reach the layer where the catalyst and the liquid coexist and thereby where the electrochemical reaction takes place. The gas diffusion layer is normally made of a porous and conductive material such as carbon paper or carbon cloth with the addition of a hydrophobic component. This hydrophobic component, typically polytetrafluoroethylene, aids in avoiding crossover of liquid electrolyte to the gas phase, which is known as flooding of the gas diffusion electrode. It is important to avoid flooding of the gas diffusion electrode in order to ensure a good performance of the electrode during electrolysis. However, flooding is always encountered during electrolysis, which causes the salts present in the liquid electrolyte to deposit on the gas diffusion layer leading to deactivation of the electrode.

Several studies have focused on the development and optimisation of carbon-based gas diffusion layers by increasing the amount of the hydrophobic component to avoid flooding or by making preferential paths for the liquid to minimise flooding.

US-A-2008/0 292 944, for example, describes a gas diffusion electrode wherein the catalyst layer is rendered hydrophobic by addition of polytetrafluoroethylene.

US-A-2005/0 214 630 discloses a gas diffusion electrode, wherein the gas diffusion layer comprises at least one water repellent conductive layer. This layer can be produced by coating a porous conductive material (e.g., carbon paper or carbon cloth) with a water-repellent resin (e.g., fluorocarbon).

EP-A-2 770 565 discloses a water-repellent layer prepared from a pore-forming agent and particles of a hydrophobic material to provide a laminate. Porosity in the water-repellent layer is accomplished, for instance, by thermolysis of the pore-forming agent.

However, all these studies use a carbon-based porous material for the gas diffusion layer. The reason why carbon-based microporous materials have been chosen is that they are thought to show no mass transfer limitations, as well as a sufficient electrical conductivity. Since sufficient electrical conductivity is important, a gas diffusion electrode typically needs a current collector (e.g., carbon cloth, carbon paper, metal mesh, metal felts, etc.), i.e., the element that transmits the electrical connection to a catalyst layer to allow for the electrochemical reaction to happen.

Moreover, in conventional gas diffusion electrode-based systems, it is not needed to have a gas diffusion layer which is selective for a specific gas reactant out of a gas mixture. However, as stated above, the consequence of using microporous systems is that it can flood and thereby decrease the mass transfer in one or two orders of magnitude.

EP-A-1 575 114 discloses direct methanol fuel cells for converting methanol to carbon dioxide, thereby generating electricity. The fuel cells comprise a gas diffusion layer for converting methanol to carbon dioxide and removing it from the reaction site.

US-A-2008/0 292 944 discloses a method for producing a gas diffusion electrode comprising a silver catalyst on a PTFE (polytetrafluoroethylene) substrate. Pores in the electrode are made hydrophobic to counter flooding.

In principle, the key elements to prevent flooding can be derived from the Young-Laplace equation. This is the relationship between the contact angle, liquid surface tension, and critical liquid entry pressure of a certain liquid in a micropore (in fact, strictly valid for cylindrical pores):

$$Δ P = \frac{2 {γ}_{L} cos θ}{{r}_{max}}$$

where ΔP=P_{L}−P_{G} is the Laplace or breakthrough pressure (the pressure required to force the liquid to enter the pore), γ_{L} is the liquid surface tension, θ is the liquid-solid contact angle, and rₘₐₓ is the maximum pore radius in the microporous membrane. It is evident that the presence of organic components (e.g., products from reducing carbon dioxide), temperature, and pressure fluctuations are of importance.

There remains a need in the art for a process for electrochemically converting a gas that exhibits a low level of flooding. Objective of the invention is to address this need in the art.

The inventors surprisingly found that this objective can, at least in part, be met by a gas diffusion layer that is based on a non-porous, gas permeable layer.

Accordingly, in a first aspect, the invention is directed to a process for electrochemically converting a reactant gas, comprising reacting a reactant gas at a gas diffusion electrode to form a product gas and/or a liquid product, wherein the gas diffusion electrode comprises a gas diffusion layer comprising a non-porous layer that is permeable to carbon monoxide and/or carbon dioxide gas, and a porous layer, and

the reactant gas comprises carbon monoxide and/or carbon dioxide.

The process can be advantageously performed with a low level of flooding. The invention further allows to electrochemically convert the reactant gas to one or more valuable chemical compounds, even at higher operating pressures. In addition, the invention improves the overall electrochemical performance due to higher current densities and Faradaic efficiencies, less to no flooding and extended electrode lifetime.

The process of the invention may comprise introducing the reactant gas into a cathode compartment of an electrochemical cell. Preferably, the reactant gas is reduced in the cathode compartment. The cathode compartment may comprise a cathode material, a catholyte and/or one or more salts to, for example, improve electrical conductivity.

The cathode compartment may comprise a gas compartment. The gas compartment may be separated from a further compartment, such as a catholyte compartment, of the cathode compartment. In particular, the gas compartment may be separated from the further compartment by the gas diffusion electrode. The process of the invention may comprise introducing the reactant gas into the gas compartment. The gas diffusion layer allows the reactant gas, in particular the carbon monoxide and/or carbon dioxide, to permeate, as defined in this disclosure, from one side of the gas diffusion electrode, such as the gas compartment, into another side of the gas diffusion electrode, such as the further compartment. The further compartment comprises a fluid medium, preferably a liquid medium. The liquid medium may comprise one or more electrolytes. The further compartment may be separated from an anode compartment of the electrochemical cell, for example, by means of any suitable membrane known to the skilled person.

The cathode compartment may be separated from an anode compartment of the electrochemical cell. Both compartments may be separated from each other by the gas diffusion electrode. The process of the invention may comprise introducing the reactant gas into the cathode compartment, where the cathode compartment comprises a fluid medium, preferably a liquid medium. The reactant gas may be introduced into the cathode compartment together with a fluid medium, such as a liquid medium. The medium may comprise one or more electrolytes. The gas diffusion layer as part of the gas diffusion electrode prevents liquid from permeating from either side of the gas diffusion electrode to the other side.

Depending on the source of the reactant gas, it may require compression, for example, by means of one or more compressors. The reactant gas may be compressed to an absolute temperature of 20 bar or more, such as 30 bar or more, 40 bar or more, 50 bar or more, 60 bar or more, or 70 bar or more, and/or, for example, 200 bar or less, such as 190 bar or less, 180 bar or less, 170 bar or less, 160 bar or less, or 150 bar or less. In particular, the absolute pressure of the reactant gas may be 20-200 bar. Preferably, the absolute pressure of the reactant gas is 20-180 bar, such as 30-150 bar or 40-120 bar.

The electrochemical cell may be operated at an ambient pressure or at an elevated absolute pressure. The absolute pressure in the electrochemical cell may be 20 bar or more, such as 30 bar or more, 40 bar or more, 50 bar or more, 60 bar or more, or 70 bar or more, and/or, for example, 200 bar or less, such as 190 bar or less, 180 bar or less, 170 bar or less, 160 bar or less, or 150 bar or less. In particular, the absolute pressure in the electrochemical cell may be 20-200 bar. Preferably, the absolute pressure in the electrochemical cell is 20-180 bar, such as 30-150 bar or 40-120 bar.

The process of the invention may further comprise collecting the product gas and/or liquid product from, for example, the cathode compartment. The product gas may be collected from the gas compartment and/or the further compartment. The liquid product may be collected from the further compartment.

The reactant gas is preferably a gaseous reactant for an electrochemical conversion. The reactant gas may be treated to remove contaminants or impurities that would negatively affect the invention. The reactant gas preferably comprises carbon dioxide. In a preferred embodiment, 50% or more by total volume of the reactant gas consists of carbon monoxide and/or carbon dioxide, such as 70% or more, 80% or more, 90% or more, or 95% or more.

The gas diffusion layer according to the invention may be considered an asymmetric membrane with a dense structure that presents no detectable pore at the limits of electron microscopy. A mixture of molecules is transported through such membranes by sorption-diffusion mechanisms under the driving force of a partial pressure gradient of the reactant gas across the membrane. The asymmetric membranes in this disclosure comprise a selective layer (skin layer) supported on a microporous support layer that provides mechanical support. The skin layer is selective at least to the abovementioned gas species that are permeable through such a membrane, namely carbon monoxide and/or carbon dioxide.

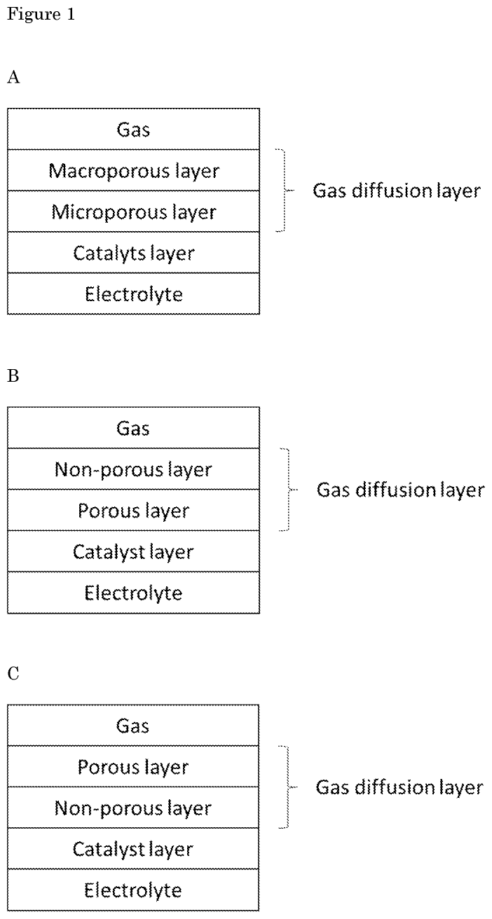

The invention takes a completely different approach than the prior art attempts to reduce flooding, by not focusing on necessarily microporous systems. In a conventional gas diffusion layer, the working of the gas diffusion layer is based on the diffusion mechanism, allowing gas to diffuse through the pores of the gas diffusion layer (FIG. 1A). However, the invention is based on a different mechanism, viz. a sorption-diffusion mechanism, wherein the reactant gas is absorbed in the non-porous layer, and desorbed at the other side of the membrane (FIGS. 1B and 1C). That is, the gas is solubilised in the non-porous, gas permeable layer that can be polymeric, where the gas moves through the interstitial space of the molecules in said layer. Due to the high solubility of gases, such as carbon dioxide, in the layer, the use of a non-porous, gas permeable layer allows a high gas permeance, up to 260 m³_{STP}·m⁻²·h⁻¹·bar⁻¹ (m³_{STP} is Standard Cubic Metre), for a layer thickness of 1.2 μm (yielding a permeability coefficient of 114 000 Barrer), and thereby, mass transfer resistance can be minimised. The value of up to 260 m³_{STP}·m⁻²·h⁻¹·bar⁻¹ corresponds to a value of up to 31.8.10⁻⁶ mol·m⁻²·s⁻¹·Pa⁻¹.

The non-porous, gas permeable layer has the capability of separating gas streams from liquid streams, thereby avoiding crossover of liquid to the gas compartment and thus ensuring an optimal performance of the electrochemical system. The use of a non-porous, gas permeable layer provides better properties against flooding. It permits operation at elevated pressures and thereby an improvement of the overall productivity.

The term “porous” as used in this disclosure is meant to refer to a material which has voids throughout the internal structure which form an interconnected continuous path from one surface to the other. In particular, a porous material in the context of this disclosure has a porosity in the range of 10-95%, such as 20-90%, 30-80%, 40-75%, or 50-70%. The term “porosity” as used in this disclosure is meant to refer to a measure of void spaces (e.g., emptiness) in a material, and is typically a fraction of the volume of voids over the total volume.

The term “non-porous” as used in this disclosure means essentially impermeable to liquids, such as water. More in particular, a non-porous layer preferably has a porosity of 10% or less, preferably 5% or less, such as 2% or less or 1% or less.

The non-porous layer may comprise any material as long as the layer is non-porous but permeable to at least one gas as described in this disclosure. In particular, the non-porous layer may be polymeric.

The non-porous, polymeric layer that is permeable to carbon monoxide and/or carbon dioxide gas may comprise one or more materials selected from the group consisting of polyorganosilicons (such as poly(1-(trimethylsilyl)-1-propyne (PTMSP)), polysiloxanes (such as polydimethylsiloxane (PDMS)), polysilanes (such as poly(vinyltrimethylsilane) (PVTMS)), polyolefins (such as polymethylpentene (PMP) and poly(ethylene glycol) (PEG)), aromatic polymers (such as poly(p-phenylene oxide) (PPO) and polysulphones), polyacrylonitrile (PAN), polypropylene hollow fibres (Oxiphan), polyvinyl amines (PVAm), polyvinyl alcohol (PVA), polyethyleneimines (PEI), and the like. Preferably, the non-porous layer comprises one or more selected from PTMSP, PDMS, PVTMS, PMP and PPO.

Advantageously, each of these preferred materials is liquid-repellent. Hence, while being permeable to the gaseous reactants, the resulting layers are impermeable to liquids, such as aqueous and non-aqueous electrolytes, including water (and thus preventing flooding completely).

The gas permeability of the non-porous layer may, for example, be expressed in Barrer (1 Barrer=3.348×10⁻¹⁶ (mol·m)/(m²·s·Pa)). The non-porous layer may have a permeability coefficient to the carbon dioxide and/or carbon monoxide gas of at least 1×10² Barrer. The permeability coefficient may be up to 1×10⁵ Barrer or less. In particular, the permeability coefficient of the layer is 2.5×10² Barrer to 1×10⁵ Barrer, such as in the range of from 5×10² Barrer to 5×10⁴ Barrer.

Barrer is a unit for gas permeability, that can be calculated back from a limiting situation involving the electrochemical reduction of carbon dioxide using a gas diffusion electrode as described in this disclosure. In this situation, carbon dioxide travels through the gas diffusion layer (asymmetric membrane) to be consumed at the catalyst layer in an electrochemical reaction involving two electrons. The boundary conditions are referred to the carbon dioxide differential partial pressure across the membrane, the current density and the membrane thickness. The mentioned polymers are specifically suitable for carbon dioxide because of their selectivity for carbon dioxide. The gas permeability values are applicable for the specific case of a gas diffusion layer according to the invention (asymmetric membrane) for carbon dioxide electroreduction with two electrons. This aids in ensuring a high gas permeance, up to 260 m³_{STP}·m⁻²·h⁻¹·bar⁻¹ (31.8·10⁻⁶ mol·m⁻²·s⁻¹·Pa⁻¹), for a (polymeric) layer thickness of 1.2 μm.

The non-porous layer may be relatively thin. For example, the layer can have a thickness in the range of from 0.1 μm to 10 μm, preferably from 0.5 μm to 5 μm, more preferably from 0.8 μm to 2.5 μm. The thinner the layer the higher the gas permeance (and therefore, the gas flux).

The porous layer allows for gas to pass through. The layer may narrow the surface pore size distribution of the porous polymeric or inorganic support and/or may act as high efficiency intermediate porous layer, i.e., to provide fast lateral diffusion of the penetrating carbon dioxide and/or carbon monoxide molecules to the inlet of the pores in the support. Further, said layer may smoothen the roughness of the porous support surface. Preferably, the porous layer is a macroporous layer, a mesoporous layer or a microporous layer. The porous layer preferably possesses an average pore diameter of 0.1 μm or more, such as 0.5 μm or more, 1 μm or more, or 5 μm or more. Typically, such as in the case of poly(1-(trimethylsilyl)-1-propyne (PTMSP), the pore size distribution of the porous layer is such that 60-95% of the pores (such as such as 70-90%, or 75-85%) have a diameter in the range of 11-16 Å, preferably in the range of 12-14 Å.

The porous layer can comprise one or more polymers as described in this disclosure. Hence, the porous layer may be a porous, polymeric layer. Said layer may, for example, comprise one or more materials selected from the group consisting of polyorganosilicons, such as poly(1-(trimethylsilyl)-1-propyne (PTMSP), polysiloxanes, such as polydimethylsiloxane (PDMS), polysilanes, such as poly(vinyltrimethylsilane) (PVTMS), polyolefins, such as polymethylpentene (PMP) and poly(ethylene glycol) (PEG), aromatic polymers, such as poly(p-phenylene oxide) (PPO) and polysulphones, polyacrylonitrile (PAN), polypropylene hollow fibres (Oxiphan), polyvinyl amines (PVAm), polyvinyl alcohol (PVA), polyethyleneimines (PEI), and the like. Preferably, the porous, polymeric layer comprises one or more selected from PTMSP, PDMS, PVTMS, PMP and PPO.

The porous layer may have a thickness of 1 μm or more. In particular, the thickness may be 1.5 μm or more, such as 2 μm or more, and/or 5 μm or less, such as 4.5 μm or less. Preferably, the thickness of the porous layer is from 1.5 μm to 4.5 μm, such as from about 1.9 μm to 4.3 μm, or from about 1.9 μm to 2.1 μm.

The gas diffusion layer may comprise a further layer comprising conductive material. The layer of conductive material may be deposited on the non-porous layer and/or the porous layer. The conductive material may be a material as described in this disclosure. For example, the conductive material may comprise conductive nanoparticles, such as carbon nanoparticles.

In operation, the gas diffusion layer is in contact with a gas stream and a catalyst layer is in contact with liquid electrolyte. The use of a gas diffusion layer of the invention in gas diffusion electrodes provides an engineering solution to avoid unwanted flooding by operating with non-porous layers while ensuring a higher flux of gases through the gas diffusion layer.

The gas diffusion electrode as described in this disclosure comprises a gas diffusion layer as described in this disclosure, and may further comprise a microporous support, and a catalyst layer as described in this disclosure. The catalyst layer may be supported on a support material, such as porous carbonaceous material.

The gas diffusion electrode can comprise a catalyst layer on the porous layer (as shown in FIG. 1B). Alternatively, the gas diffusion electrode can comprise a catalyst layer on the non-porous layer (as shown in FIG. 1C). The catalyst layer is preferably integrated onto the gas diffusion layer by deposition, ensuring a good electrical connection to provide the necessary electrons for the electrochemical reaction.

The catalyst layer typically comprises a catalytic material and a conductive material, such as a conductive material as described in this disclosure. The catalyst layer may have a thickness in the range of from 1 μm to 20 μm, such as from 5 μm to 15 μm. In particular, the thickness of the catalyst layer is from about 1.2 μm to about 17.8 μm. Preferably, the thickness is about 9 μm or less, such as from 1.2 μm to 9 μm.

The catalytic material may, for example, comprise one or more metals and/or (metal) alloys, for example, selected from the group consisting of Sn, Pb, Au, Ag, C, Ni, Fe, In, Tl, bronze, brass, Ti, Cu, Ir and Pt.

The conductive material may, for example, comprise one or more metals, (metal) alloys, and/or conductive (nano)particles), for example, selected from the group consisting of Sn, Pb, Au, Ag, C, Ni, Fe, In, Tl, bronze, brass, carbon nanoparticles, Ti, Cu, Ir and Pt.

Preferably, the conductive material is integrated in the catalytic material or is present as a separate layer, such as in the form of nanoparticles, metallic mesh, metallic gauze, paper, foam, or felt.

In a further aspect, the invention is directed to an electrolyser comprising a gas diffusion electrode as described in this disclosure. The gas diffusion electrode comprises the gas diffusion layer of the invention.

The electrolyser may comprise at least two compartments separated from each other by, for example, a (semi-)permeable separator. Preferably, the at least two compartments are separated from each other by the gas diffusion electrode. The at least two compartments may comprise an anode compartment and a cathode compartment. The cathode compartment may be arranged to receive a reactant gas as described in this disclosure. In particular, the cathode compartment may be arranged to receive the reactant gas under pressure. The absolute pressure within the cathode compartment may be 1 bar or more, such as 20 bar or more, and/or, for example 200 bar or less, such as 180 bar or less.

The cathode compartment may be arranged to electrochemically reduce the reactant gas, in particular carbon monoxide and/or carbon dioxide. The cathode compartment may comprise the gas diffusion electrode, for example, as the cathode. The gas diffusion electrode may separate the anode compartment from the cathode compartment. In operation, the reactant gas is introduced into the cathode compartment for electrochemical reduction of, for example, carbon monoxide and/or carbon dioxide. Thus, the electrolyser is arranged to electrochemically reduce a gas.

In yet a further aspect, the invention is directed to a gas diffusion electrode as described in this disclosure. The gas diffusion electrode comprises the gas diffusion layer of the invention. The gas diffusion electrode is suitable for use in an electrochemical cell, particularly to electrochemical conversion reactions, such as the electrochemically conversion of reactant gas as described in this disclosure, including, for example, carbon monoxide and/or carbon dioxide.

In yet a further aspect, the invention is directed to a method for producing a gas diffusion electrode, preferably a gas diffusion electrode as defined in this disclosure.

The method for producing a gas diffusion electrode comprising
providing a gas diffusion layer according to the invention,
optionally coating said gas diffusion layer with an electroconductive material, said material preferably comprising electroconductive particles, and
coating a catalytic layer either on the non-porous layer, or on the porous layer.

The electroconductive coating may further comprise a liquid-repellent material. This material may comprise one or more polymers as defined in this disclosure. The liquid-repellent material preferably comprises one or more of PTMSP, PDMS, PVTMS, PMP and PPO. The coating of electroconductive material may further comprise a dispersion medium, a surfactant and/or an ionomer binding agent. The electroconductive particles may comprise conductive material as described in this disclosure. The catalytic layer may be as described in this disclosure, and may further comprise a binder.

After coating, solvent may be evaporated, for instance, by a heating step.

In yet a further aspect, the invention is directed to the gas diffusion layer as described in this disclosure. In particular, the layer comprises a non-porous layer, preferably a non-porous, polymeric layer, that is permeable to carbon monoxide and/or carbon dioxide gas, and a porous layer, preferably a porous, polymeric layer. The gas diffusion layer is suitable for use in an electrolyser or electrochemical cell.

In yet a further aspect, the invention is directed to the use of a gas diffusion layer or a gas diffusion electrode as described in this disclosure in an electrochemical conversion of a gaseous reactant in a liquid electrolyte.

The permeability of the non-porous layer may be affected by conditions (such as pressure and current density) that are applied when the gas diffusion layer is employed in an electrochemical conversion. The electrochemical conversion is further suitably conducted at a current density in the range of 0.1-1500 mA/cm², such as 10-1000 mA/cm², or 50-500 mA/cm².

As an example, for a carbon dioxide electrochemical reduction process, with two electrons exchanged, in which the carbon dioxide flux is determined by the carbon dioxide consumption at the catalyst layer of the electrode, according to Faraday's Law, the gas permeability coefficient for the membrane for carbon dioxide can be calculated assuming a certain thickness of the non-porous layer, the current density of the electrode at the catalyst layer, and a certain pressure gradient across the non-porous layer (thus assuming a limiting case in which all carbon dioxide crossing the non-porous layer is consumed).

Table 1 below shows the gas permeability coefficient for carbon dioxide permeability for a gas diffusion layer having 1 μm thickness, current densities and carbon dioxide partial pressure drop values across the layer.

TABLE 1
Carbon dioxide permeability

| | CO₂ | | | |
|---|---|---|---|---|
| Current | Pressure | CO₂ flux | Permeability | Permeance CO₂ |
| Density | difference | [mol · | CO₂ | [m³_{STP} · m⁻² · |
| [mA · cm⁻²] | [bar] | m⁻² · s⁻¹] | [Barrer] | h⁻¹ · bar⁻¹] |
| 10 | 0.10 | 5.18 × 10⁻³ | 1.55 × 10³ | 4.237 |
| 100 | 0.10 | 5.18 × 10⁻² | 1.55 × 10⁴ | 42.369 |
| 10 | 1.00 | 5.18 × 10⁻³ | 1.55 × 10² | 0.424 |
| 100 | 1.00 | 5.18 × 10⁻² | 1.55 × 10³ | 4.237 |
| 1000 | 1.00 | 5.18 × 10⁻¹ | 1.55 × 10⁴ | 42.369 |
| 10 | 10.00 | 5.18 × 10⁻³ | 1.55 × 10¹ | 0.042 |
| 100 | 10.00 | 5.18 × 10⁻² | 1.55 × 10² | 0.424 |
| 1000 | 10.00 | 5.18 × 10⁻¹ | 1.55 × 10³ | 4.237 |

In order to ensure a higher flux of the gaseous reactants through the gas diffusion layer, the gas diffusion electrode can be operated at elevated pressures to promote the transport of the gases through the dense membrane. The gas diffusion electrode may, for instance, be operated at a pressure in the range of 10²-10⁸ Pa, such as 10³-10⁷ Pa, or 10⁴-10⁶ Pa. Operating the gas diffusion electrode of the invention at high pressures also provides the benefit of increasing the availability of the gas reactant in the three-boundary phase and therefore improving the production of the desired chemical.

The invention has been described by reference to various embodiments, and methods. The skilled person understands that features of various embodiments and methods can be combined with each other.

All references cited in this disclosure are hereby completely incorporated by reference to the same extent as if each reference were individually and specifically indicated to be incorporated by reference and were set forth in its entirety in this disclosure.

The use of the terms “a” and “an” and “the” and similar referents in the context of describing the invention (especially in the context of the claims) are to be construed to cover both the singular and the plural, unless otherwise indicated in this disclosure or clearly contradicted by context. The terms “comprising”, “having”, “including” and “containing” are to be construed as open-ended terms (i.e., meaning “including, but not limited to”) unless otherwise noted. Recitation of ranges of values in this disclosure are merely intended to serve as a shorthand method of referring individually to each separate value falling within the range, unless otherwise indicated in this disclosure, and each separate value is incorporated into the specification as if it were individually recited in this disclosure. The use of any and all examples, or exemplary language (e.g., “such as”) provided in this disclosure, is intended merely to better illuminate the invention and does not pose a limitation on the scope of the invention unless otherwise claimed. No language in the specification should be construed as indicating any non-claimed element as essential to the practice of the invention. For the purpose of the description and of the appended claims, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated in this disclosure.

When referring to a noun in the singular, the plural is meant to be included, or it follows from the context that it should refer to the singular only.

Preferred embodiments of this invention are described in this disclosure. Variation of those preferred embodiments may become apparent to those of ordinary skill in the art upon reading the foregoing description. The inventors expect skilled artisans to employ such variations as appropriate, and the inventors intend for the invention to be practiced otherwise than as specifically described in this disclosure. Accordingly, this invention includes all modifications and equivalents of the subject-matter recited in the claims appended hereto as permitted by applicable law. Moreover, any combination of the above-described elements in all possible variations thereof is encompassed by the invention unless otherwise indicated in this disclosure or otherwise clearly contradicted by context. The claims are to be construed to include alternative embodiments to the extent permitted by the prior art.

For the purpose of clarity and a concise description features are described in this disclosure as part of the same or separate embodiments, however, it will be appreciated that the scope of the invention may include embodiments having combinations of all or some of the features described.

The invention will now be illustrated in more detail by means of a specific example. However, the invention may be embodied in many different forms and should not be construed as being limited to the embodiments set forth in this disclosure. Rather, the example embodiment is provided so that this description will be thorough and complete, and will fully convey the scope of the invention to those skilled in the art.

### EXAMPLE

A two-compartment electrochemical reactor was used for electrochemically converting carbon dioxide to formic acid using gas diffusion electrodes based on the gas diffusion layer of the invention (dense asymmetric PTMSP membrane). The reactor consisted of a platinum plate anode (10 cm²) and a tin-based gas diffusion electrode (10 cm²), prepared by coating a PTMSP asymmetric membrane with a dispersion of carbon nanotubes+Nafion®, until a resistivity of about 22 ohm was obtained, at 7.7 mg/cm². Tin nanoparticles were then sprayed on the surface, obtaining a loading of 2.7 mg/cm². Electrolytes used: anolyte 0.5 M H₂SO₄ (250 ml), and catholyte: 1.0 M KHCO₃ (250 ml).

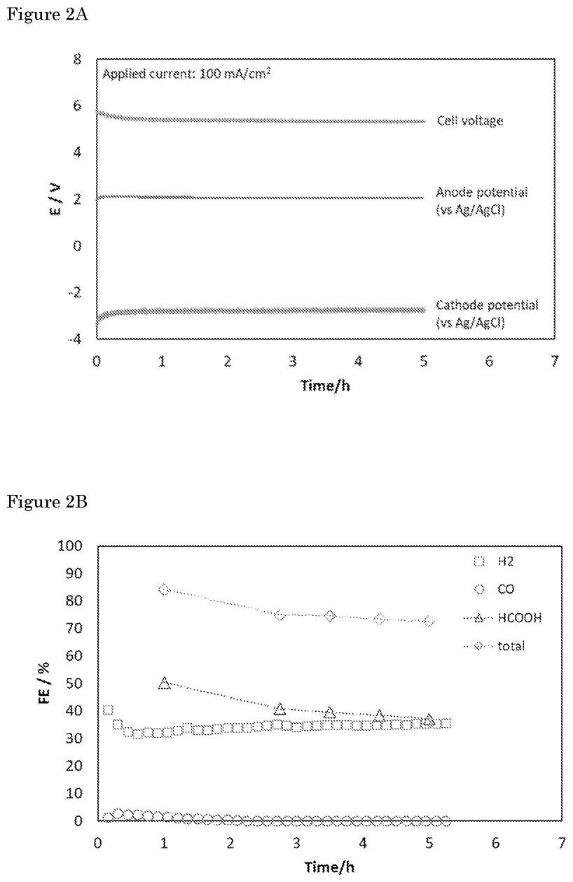

Chronopotentiometry testing was performed at −1 A (−100 mA/cm²) (FIG. 2A). Cathode potential and anode potentials were measured and reported in volts (V) versus Ag/AgCl. Cell potential was measured and reported in volts (V). Cathode potential stabilised at about −2.8 V versus Ag/AgCl, and anode potential around about 2.05 V versus Ag/AgCl, during electrolysis. Faraday efficiency of 40-50% towards target, formic acid molecule, was obtained during electrochemical conversion of carbon dioxide on custom made gas diffusion electrode with a dense membrane layer to prevent flooding (FIG. 2B). No flooding was observed during electrolysis.

1. A process for electrochemically converting a reactant gas, the process comprising reacting a reactant gas at a gas diffusion electrode to form one or more of a product gas and a liquid product,
wherein the gas diffusion electrode comprises a gas diffusion layer comprising a non-porous layer that is permeable to carbon monoxide and/or carbon dioxide gas, and a porous layer, and
the reactant gas comprises one or more of carbon monoxide and carbon dioxide.

2. The process of claim 1, comprising introducing the reactant gas into a cathode compartment of an electrochemical cell.

3. The process of claim 2, wherein the reactant gas is introduced into a gas compartment of the cathode compartment, the gas compartment being separated from a catholyte compartment by the gas diffusion electrode.

4. The process of claim 2, wherein the gas diffusion electrode separates the cathode compartment from an anode compartment of the electrochemical cell.

5. The process of claim 2, further comprising collecting one or more of the product gas and the liquid product from the cathode compartment.

6. The process of claim 2, wherein an absolute pressure in the electrochemical cell is 20 bar or more.

7. The process of claim 1, wherein the gas diffusion electrode further comprises a catalyst layer.

8. The process of claim 7, wherein the catalyst layer is on the porous layer of the gas diffusion layer, or on the non-porous layer of the gas diffusion layer.

9. The process of claim 7, wherein the catalyst layer comprises a catalytic material and a conductive material.

10. The process of claim 9, wherein the conductive material is integrated in the catalytic material or is present as a separate layer.

11. The process of claim 1, wherein the non-porous layer is a non-porous, polymeric layer and the porous layer is a porous, polymeric layer.

12. The process of claim 1, wherein the non-porous layer has a coefficient for permeability to one or more of carbon monoxide gas and carbon dioxide gas of 1×10² to 1×10⁵ Barrer.

13. The process of claim 1, wherein the non-porous layer has a thickness in the range of from 0.1 μm to 10 μm.

14. The process of claim 1, wherein the porous layer has a thickness in the range of from 1 μm to 5 μm.

15. An electrolyser, comprising a gas diffusion electrode as defined in claim 1.

16. The electrolyser of claim 15, comprising an anode compartment and a cathode compartment, wherein the cathode compartment comprises the gas diffusion electrode, or the gas diffusion electrode separates the anode compartment from the cathode compartment.

17. A gas diffusion electrode as defined in claim 1.

18. A method for producing a gas diffusion electrode comprising:
providing a gas diffusion layer according to claim 1,
coating a catalytic layer on the non-porous layer or on the porous layer of the gas diffusion layer.

19. The method of claim 18, wherein the gas diffusion electrode comprises a gas diffusion layer comprising a non-porous layer that is permeable to carbon monoxide and/or carbon dioxide gas, and a porous layer.

20. The method of claim 18, further comprising coating the gas diffusion layer with an electroconductive material.

21. The method of claim 20, wherein the electroconductive material comprises electroconductive particles.

22. A gas diffusion layer as defined in claim 1.

23. The process of claim 1 wherein the process results in an electrochemical conversion of a gaseous reactant in a liquid electrolyte.

24. The process of claim 23, wherein the electrochemical conversion is the electrochemical conversion of one or more of carbon monoxide and carbon dioxide.
